(19) United States
(12) Patent Application Publication
(10) Pub. No.: US 2006/0175743 A1
(43) Pub. Date: Aug. 10, 2006

(54) Length adjustable gas spring

(76) Inventor: Eui Hyup Chung, Chungchungbookdo (KR)

Correspondence Address: LADAS & PARRY LLP, 224 SOUTH MICHIGAN AVENUE, SUITE 1600, CHICAGO, IL, 60604, US

(21) Appl. No.: 10/526,797

(22) PCT Filed: Sep. 9, 2003
(86) PCT No.: PCT/KR03/01854

§ 371 Date: Sep. 20, 2005

(30) Foreign Application Priority Data
Sep. 10, 2002 (KR) 10-2002-0054651

(51) Int. Cl. F16F 5/00

(52) U.S. Cl. 267/64.12

(57) ABSTRACT

Whereas existing length adjustable gas spring is comprised of double cylinder structure that is made up of external cylinder (10a) and internal cylinder (44a), length adjustable gas spring of this invention is made up of merely one cylinder (30). It is comprised of single cylinder structure in which pipe for gas transport (70, 70′, 70″, 70*) penetrates through the inside of this piston. Accordingly, this invention minimizes the number of parts that are assembled inside the cylinder (30), and simplifies structure of parts, which translates into the turning point for quality enhancement and reduction in the production cost. This invention is configured in a way that the spindle support (130) is fixated between the projected outward projection (122) and projected outward projection (123) that is projected out into the inner direction at the lower part of the outer drum (120). Moreover, it is possible to easily realize new functions that could not be realized on existing double cylinder structured matter due to structural limitation on this single cylinder structured length adjustable gas spring.

### BACKGROUND OF THE INVENTION

1. Field of the Invention

This invention relates to the length adjustable gas spring. In more detail, this invention is a single cylinder structure that is comprised of one cylinder. Accordingly, this invention minimizes the number of parts that are assembled inside the cylinder (30), and simplifies structure of parts, which translates into the turning point for quality enhancement and reduction in the production cost. This invention is configured in a way that the spindle support (130) is fixated between the projected outward projection (122) and projected outward projection (123) that is projected out into the inner direction at the lower part of the outer drum (120).

2. Description of the Prior Art

Length Adjustable Gas Spring is a very important product that is needed for the adjustment of chair's seating length.

Existing length adjustable gas spring is double cylinder structure that is comprised of external cylinder (10a) and internal cylinder (44a), and is made up of numerous parts such and the assembled valve entity (40a) that is comprised of super precise parts include gas opening and shutting pin (100a) and assembled piston entity (80a) that is comprised of various precise parts. The following is the detailed explanation based on the use of attached figures.

FIG. 1 is the vertical sectional view that show existing length adjustable gas spring.

FIG. 2 is the sectional view that shows assembled valve entity of the existing length adjustable gas spring.

FIG. 3 is the sectional view that shows assembled piston entity of the existing length adjustable gas spring.

As shown on FIG. 1, piston rod (30a) is attached at the low part of the outer drum (20a) where rod shaped external cylinder (10a) and external cylinder (10a) are inserted when it comes to existing length adjustable gas spring. Surface of external cylinder (10a) is chrome plated after the polishing process. At the upper side of the above mentioned external cylinder (10a), push bar (14a) is fixated and placed by push support (16a), and the lower part of the push bar is placed so that it faces gas opening and shutting pin (100a). The above mentioned gas opening and shutting pin (100a) is installed in a way that up/down movement is enabled on the valve assembly entity (40a) assembled within the above mentioned external cylinder (10a).

On the above mentioned outer drum (20a), spindle support (50a) is fixated at the lower side of outer drum due to the welding process, and fixates the above mentioned piston rod (30a) through spindle support (50a). Upper part of the above mentioned external cylinder (10a) comprises tapered sloped part (12a). Internal cylinder (44a) is placed in the above mentioned external cylinder (10a). Trust bearing (60a) and rubber that prevents vibration (62a) are saddled on spindle support (50a). Moreover, lower part of the above mentioned piston rod (30a) is fixated in a way that conjoining or separation is enabled onto the above mentioned spindle support (50a) based on the use of clip (70a).

FIG. 2 is the sectional view that shows the valve assembly entity as it relates to the existing length adjustable gas spring. The above mentioned valve assembly entity (40a) formed round column in overall. Valve hole towards hole of the inner circumference (41a) where the above mentioned gas opening and shutting pin (100a) is inserted is formed at the center, and O-ring is inserted into O-ring groove (43a) of outer side to maintain gas sealing.

Center of the inner side of the above mentioned valve assembly entity (40a) is formed with space part (46a) for the gas logistics. At least two O-ring (45a) are placed within this space part (46a) to maintain gas sealing. Moreover, holder at the inner side (47a) is installed at the above mentioned space part (46a) to maintain distance of the above mentioned O-ring (45a) and to ensure effective slide operation of the above mentioned gas opening and shutting pin (100a).

Precise holes are drilled into the one side of this holder at the inner side (47a) so that gas passes through by being connected to the hole for gas transport (42a). As shown on FIG. 1, slide supplementary material (52a) is placed between external cylinder (10a) and outer drum (20a) to enable slide movement of external cylinder (10a).

When FIG. 3 is used as reference to explain about the piston (80a), installed at the upper side of the above mentioned piston rod (30a), the above mentioned piston (80a) and piston rod (30a) are the parts that are separated from each other. Piston rod (30a) is produced by subjecting metal bar to processing process, surface polishing process and chrome plating process. The above mentioned piston (80a) is fixated by the Riveting work of the upper part of the piston rod (30a) after inserting into the upper part of the piston rod (30a). To maintain gas sealing at the inner and outer side of the piston (80a), various O-ring (82a) are inserted and installed. Rod Guide (83a) is assembled at the lower part of the inner side of the external cylinder (10a), and Rod Seal (84a) is assembled at the upper part of the Radial Guide to maintain the gas sealing of the external cylinder (10a). Ring (88a), double washer (85a) etc are used for the conjoining of the above mentioned piston (80a), and double washer (85a) supports the lower end of the above mentioned piston (80a).

Direction of arrow on FIG. 3 shows the state in which the gas moves from the chamber room (C) to chamber room (A).

Existing length adjustable gas spring, comprised as mentioned on this structure, presses down the push bar (14a) that is installed at the foremost upper end of the external cylinder (10a) as shown on FIG. 1. Then, small diameter part (102a), situated at the center of the gas opening and shutting pin (100a), moves downward when the push bar (14a) presses down on the gas opening and shutting pin (100a).

When the above mentioned gas opening and shutting pin (100a) is pressed, small diameter part (102a) that is at the center of the above mentioned gas opening and shutting pin goes down, and space part (46a) and chamber room (A) open mutually. Gas of the above mentioned chamber room (C) moves to the chamber room (A) at the one-time since the above mentioned space part (46a) is connect to go through with hole for gas transport (42a).

The above mentioned piston (80a) effectively pushes out the piston (80a) since gas pressure in the chamber room (C) is higher than that of the chamber room (A).

The above mentioned piston (80a) effectively pushes out the piston (80a) since gas pressure in the chamber room (C) increases higher than the gas pressure level in the chamber room (A). Moreover, piston (80a) is fixated on the spindle support (50a) of the above mentioned outer drum (20a). Thus, the above mentioned external cylinder (10a) increases due to the counter reaction.

As mentioned above, the basic structure of the existing length adjustable gas spring is double cylinder structure that is comprised of external cylinder (Oa) and internal cylinder (44a). Since it is comprised of numerous parts such as assembled valve entity (40a) made of super precise parts including gas opening and shutting pin (100a) and assembled piston entity (80a) made of numerous precise parts, it causes increase in the cost of production, increase in the number of defects due to the failure in managing super precise parts, decreased quality due to the defective manufacturing process, and increase in the cost of manufacturing.

Productivity and cost of cost decreases and increases, respectively, since spindle support (50a) is fixated on the outer drum (20a) lower part towards the inner side through welding.

### SUMMARY OF THE INVENTION

This invention relates to the length adjustable gas spring that uses pipe for gas transport (70, 70′, 70″, 70*) made of synthetic resin or metallic pipe. Structure of this invention is that of single cylinder structure (30). Moreover, spindle support (130) is fixated between the projections without welding towards the lower part of the outer drum (120). Accordingly, this invention offers innovative turning point for increased quality, reduction in the cost of production, and increased productivity.

### BRIEF DESCRIPTION OF THE DRAWINGS

FIG. 1 is the vertical sectional view that show existing length adjustable gas spring

FIG. 2 is the sectional view that shows assembled valve entity of the existing length adjustable gas spring

FIG. 3 is the sectional view that shows assembled piston entity of the existing length adjustable gas spring

FIG. 4 is the vertical sectional view that shows length adjustable gas spring of this invention

FIG. 5 is the vertical sectional view that shows another length adjustable gas spring of this invention

FIG. 6 is the vertical sectional view that shows yet another length adjustable gas spring of this invention

FIG. 7 is the vertical sectional view that shows yet another length adjustable gas spring of this invention

FIG. 8 is the sectional view that shows cylinder when it comes to this invention

FIG. 9 is the sectional view that shows push bar when it comes to this invention

FIG. 10 is the sectional view that shows push support when it comes to this invention

FIG. 11 is the sectional view that shows valve seal when it comes to this invention

FIG. 12 is the diagram that shows pipe for gas transport when it comes to this invention

FIG. 13 is the diagram that shows another pipe for gas transport when it comes to this invention

FIG. 14 is the diagram that shows yet another pipe for gas transport when it comes to this invention

FIG. 15 is the diagram that shows yet another pipe for gas transport when it comes to this invention

FIG. 16 is the diagram that shows piston rod when it comes to this invention

FIG. 17 is the sectional view that shows another piston rod when it comes to this invention

FIG. 18 is the sectional view that shows piston when it comes to this invention

FIG. 19 is the sectional view that shows sectional view that shows another piston when it comes to this invention

FIG. 20 is the sectional view that shows yet another piston when it comes to this invention

FIG. 21 is the sectional view that shows rod guide when it comes to this invention

FIG. 22 is the sectional view that shows sectional view that shows rod seal when it comes to this invention

FIG. 23 is the outer drum when it comes to this invention

FIG. 24 is the sectional view that shows spindle support when it comes to this invention

### EXPLANATION ON THE SYMBOLS OF KEY PARTS OF THE FIGURE

cylinder (30), sloped side (31), end part of the upper side (32), end part of the lower side (33), boundary side (34), inner side (35,35-1), pass-through hole at the upper part (36), pass-through hole at the lower part (37), cylinder surface (38), sloped side (39), push bar (40), small diameter surface (41), rectangular gap surface (42), large diameter surface (43), inner side of the central groove part (44), end part of the groove part (45), central groove (46), pass-through hole (47), push support (50), pass-through hole (51), insertion part (52), suspension sill (53), valve seal (60), seal lip (61,62), surface (63,64,65), space surface (66,68), pass-through hole (67), surface of sloped part (69), pipe for gas transport (70,70′,70″,70*), end part of the upper part (71,71′,71″,71*), gas transport hole (72,72′,72″,72*), passageway for gas transport (73,73′,73″,73*), end part of the lower side (74,74′,74″, 74*), swelled oval spherical surface (75″,75*), gas sealing hole (76″,76*,77″,77*), push pin (78″,78*), projected part (78″-1,78″-2,78*-1,78*-2), metallic bar (79,79″,79′-1,79′-2,79*-1,79*-2), piston (80,80′,80″), double seal lip (81,81-1,84,84-1), O-ring (81′,81″,84′,84″), inner diameter part (82), groove (82′,83′,83′-1,83″,83″-1,85″), hole (86,86′,86″), metallic core material (87), gas transport groove (87″), metallic core material surface (88), projected part (89), piston rod (90), fixation board (91), end part of the upper part (91′), surface of upper part (92), inner groove (92′), rod for lower side conjoining (93′), part of lower side (94′), surface of the middle part (95,95′), surface of lower part (96), side of small diameter part (96′), groove (97,97′), gas sealing elastic entity (98′), conjoining projection (99′), rod guide (100), inner side of circumference (101), center hole (105), rod seal (110), metallic core material (111), outer side of circumference (112), seal lip (113,114), center hole (115), groove (116), outer drum (120), projected outward projection (121,122,123), spindle support (130), sloped part (131), hole (132), surface of the center part (134), slide supplementary material (140), retainer (150), clip (160), vibration-proof rubber (170), round shape (R′,R*), X chamber room (X), Y chamber room (Y)

### DETAILED DESCRIPTION

To solve the above mentioned problems, the basic structure of this invention is single cylinder structure that is comprised of one cylinder (30). The purpose of this invention is to minimize number of parts that are assembled inside the cylinder (30). Spindle support (130) is fixated between projected outward projection (123) and projected outward projection (122) towards the inner direction of the lower part of the outer drum (120) without being welded. The purpose of this invention is to increase productivity and reduce cost of production.

### Composition of the Invention

To achieve the above mentioned purpose, length adjustable gas spring is comprised of; cylinder shaped outer drum (120); spindle support (130) that is inserted and conjoined onto the lower part of the inner side of the above mentioned outer drum (120); slide supplementary material (140) that is comprised by being injected at the upper part of the above mentioned outer drum (120)'s inner side; cylinder (30) of single cylinder structure that is supported through the above mentioned slide supplementary material (140) after being inserted to the above mentioned outer drum (120); push support (50) comprised at the upper part of the above mentioned cylinder (30)'s inner side; push bar (40) of synthetic resin material that is comprised after being projected towards the outer side of the above mentioned cylinder (30) after being inserted into the above mentioned push support (50); valve seal (60) of rubber material and elastic entity that is comprised at the lower part of the above mentioned push support (50); piston (80,80′,80″) of rubber material and elastic entity that is comprised at the center of the above mentioned cylinder (30)'s inner side; rod seal (110) of rubber and elastic entity material that is comprised at the lower part of the above mentioned cylinder (30)'s inner side; rod guide (100) of synthetic resin material that is comprised at the upper part of the above mentioned rod seal (110); retainer (150) that is comprised at the upper part of the above mentioned spindle support (130); vibration-proof rubber (170) that mitigates the shock of cylinder (30) that moves up and down after being comprised at the upper part of the above mentioned retainer (150); piston rod (90,90′) that is fixated onto the lower part of the above mentioned spindle support (130) by clip (160) and that passes through the above mentioned rod guide (100) and rod seal (110) by being conjoined onto the above mentioned piston (80,80′,80″); and pipe for gas transport (70,70′,70″,70*) of synthetic resin or metallic material that is inserted to the push bar (40) by passing through the piston (80,80′,80″), valve seal (60) and push support (50) that are comprised at the center and upper part of the above mentioned cylinder (30)'s inner side.

The following is detailed explanation based on the use of attached figures.

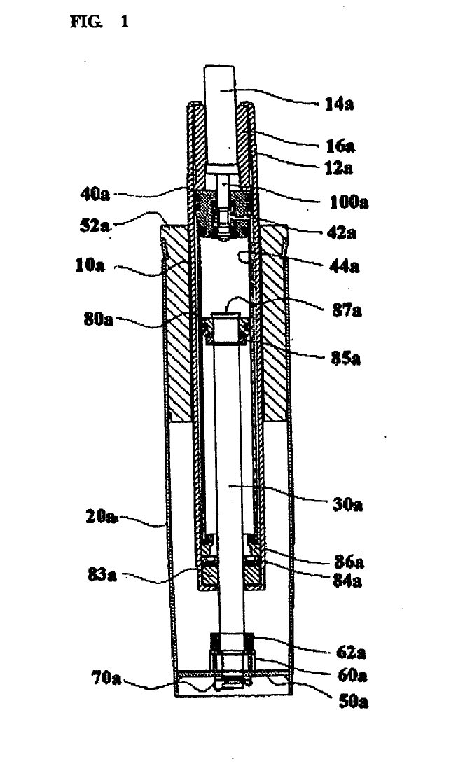

FIG. 1 is the vertical sectional view that show existing length adjustable gas spring.

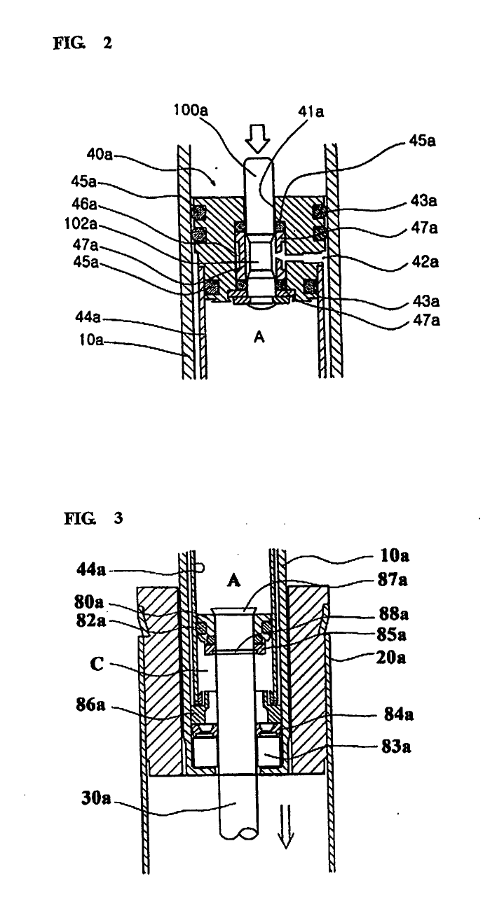

FIG. 2 is the sectional view that shows assembled valve entity of the existing length adjustable gas spring.

FIG. 3 is the sectional view that shows assembled piston entity of the existing length adjustable gas spring.

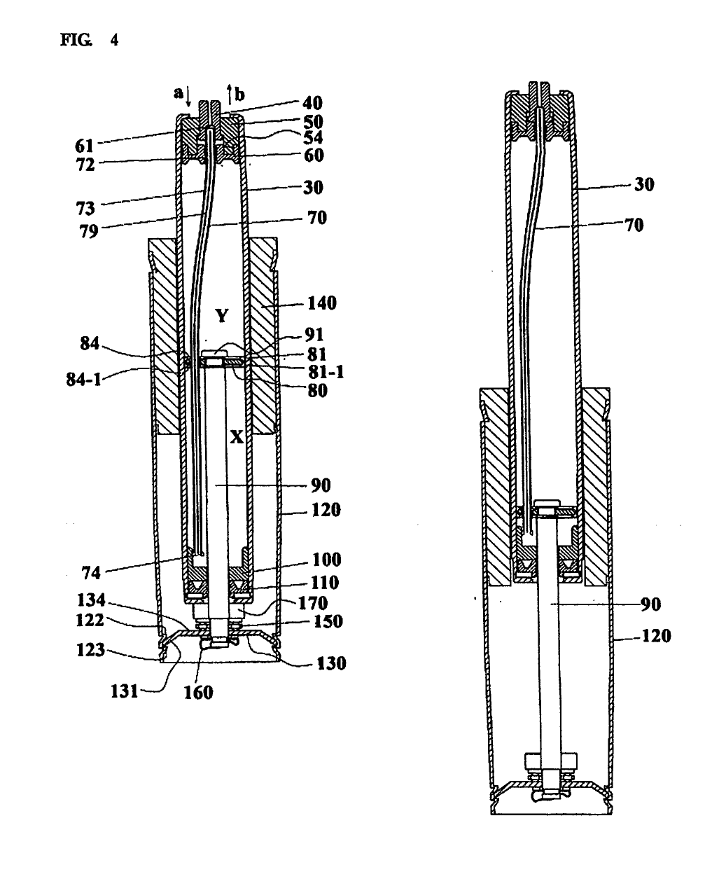

FIG. 4 is the vertical sectional view that shows length adjustable gas spring of this invention.

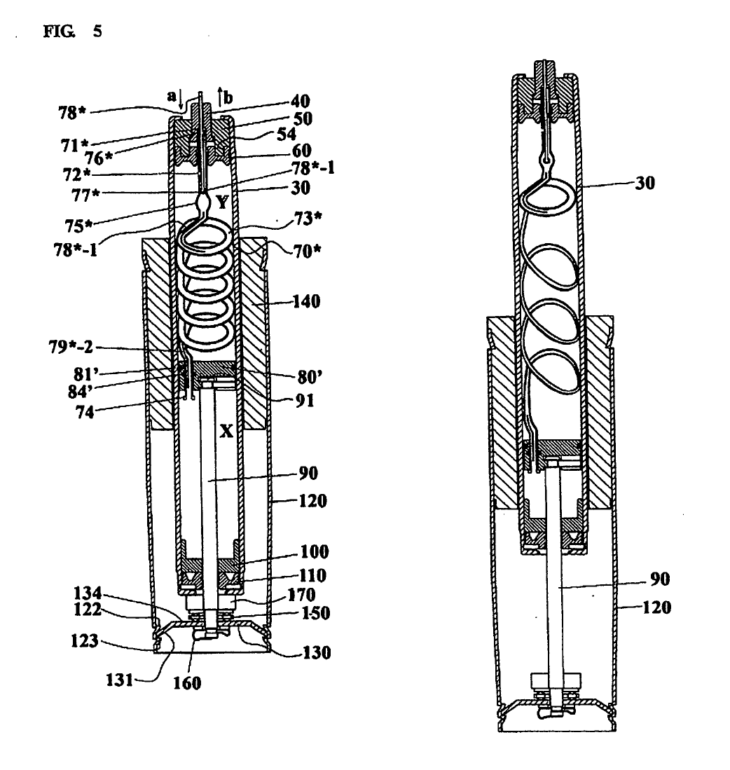

FIG. 5 is the vertical sectional view that shows another length adjustable gas spring of this invention.

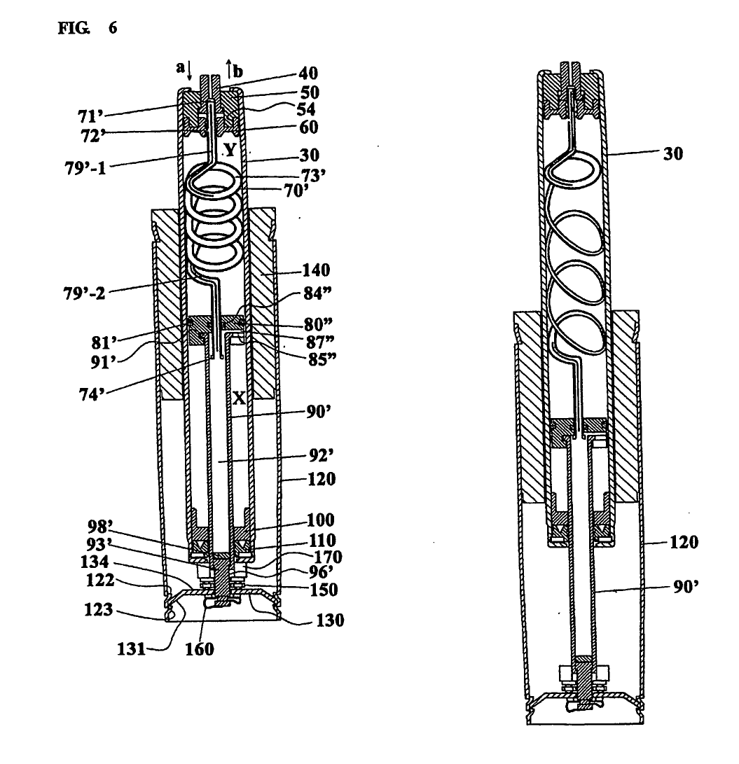

FIG. 6 is the vertical sectional view that shows yet another length adjustable gas spring of this invention.

FIG. 7 is the vertical sectional view that shows yet another length adjustable gas spring of this invention.

FIG. 8 is the sectional view that shows cylinder when it comes to this invention.

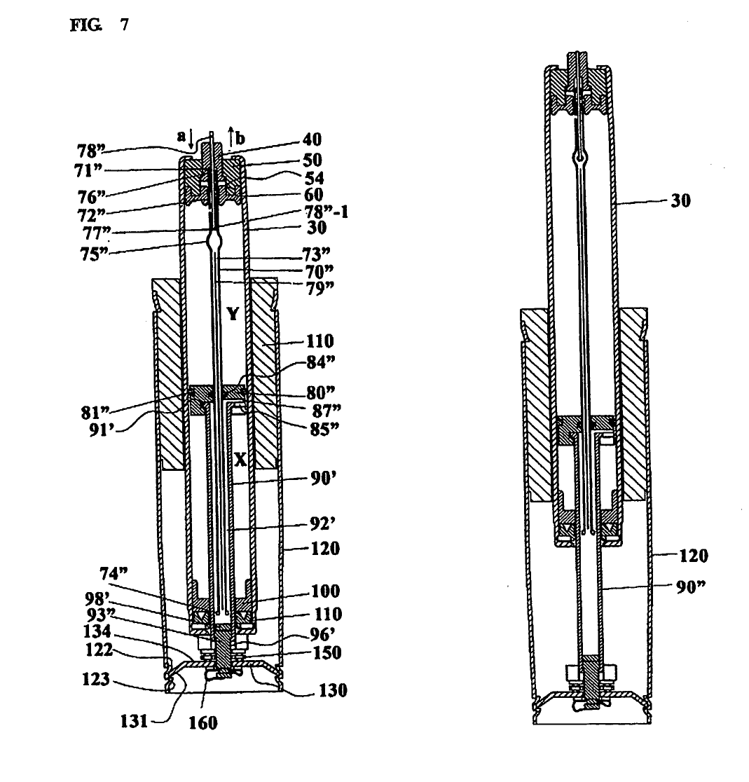

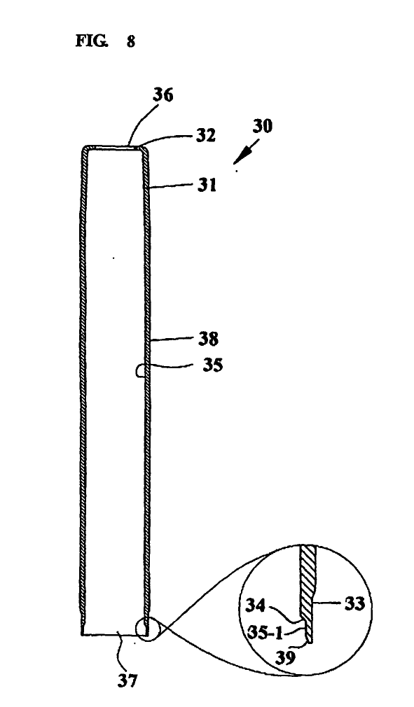

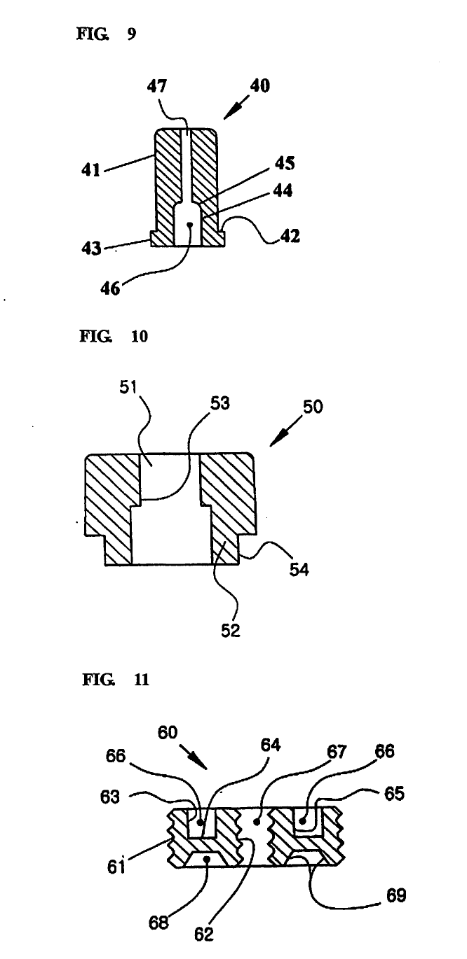

FIG. 9 is the sectional view that shows push bar when it comes to this invention.

FIG. 10 is the sectional view that shows push support when it comes to this invention.

FIG. 11 is the sectional view that shows valve seal when it comes to this invention.

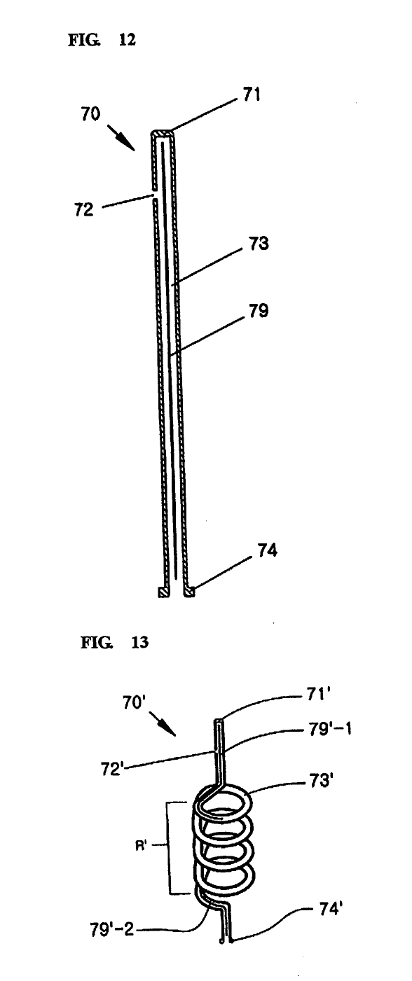

FIG. 12 is the diagram that shows pipe for gas transport when it comes to this invention.

FIG. 13 is the diagram that shows another pipe for gas transport when it comes to this invention.

FIG. 14 is the diagram that shows yet another pipe for gas transport when it comes to this invention.

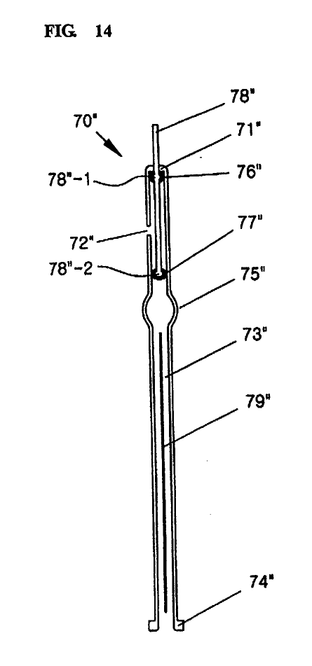

FIG. 15 is the diagram that shows yet another pipe for gas transport when it comes to this invention.

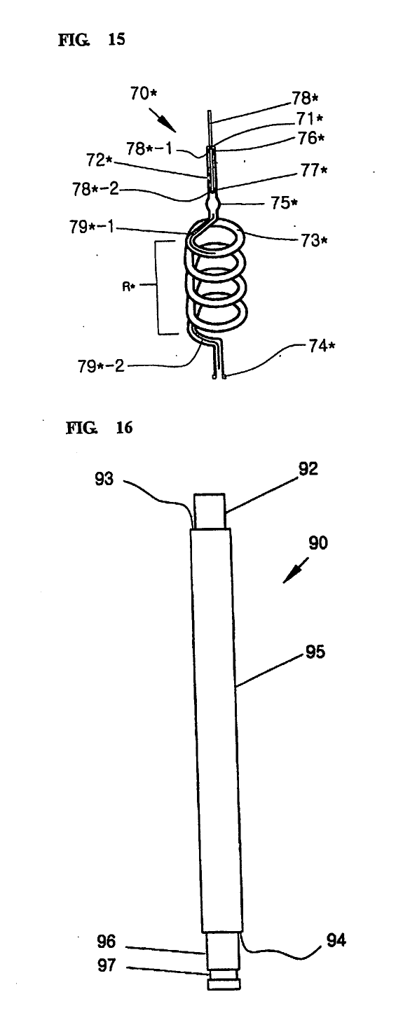

FIG. 16 is the diagram that shows piston rod when it comes to this invention.

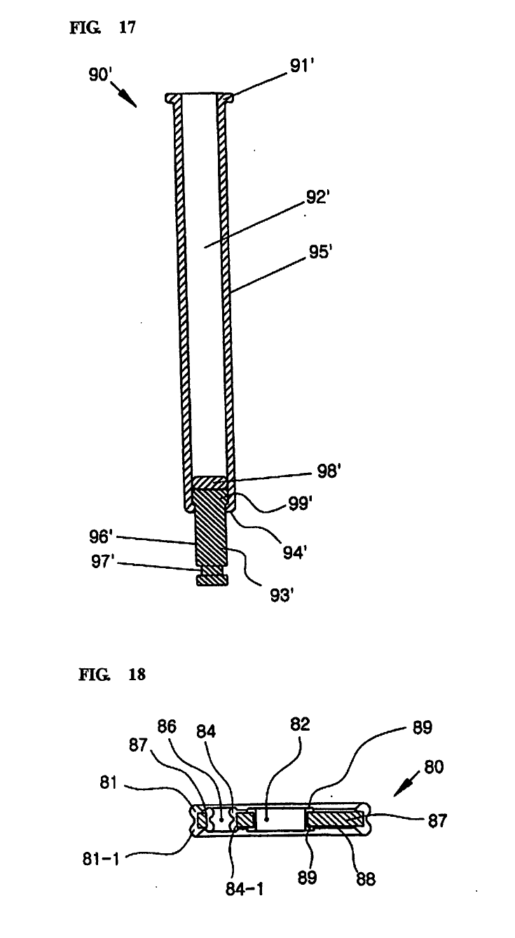

FIG. 17 is the sectional view that shows another piston rod when it comes to this invention.

FIG. 18 is the sectional view that shows piston when it comes to this invention.

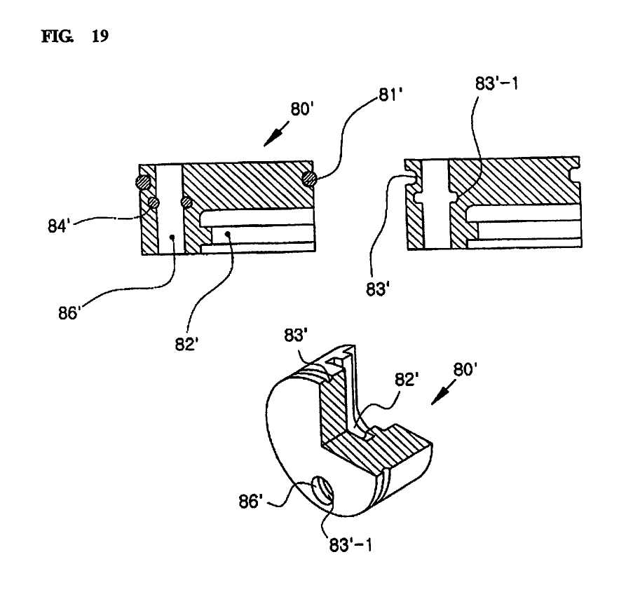

FIG. 19 is the sectional view that shows sectional view that shows another piston when it comes to this invention.

FIG. 20 is the sectional view that shows yet another piston when it comes to this invention.

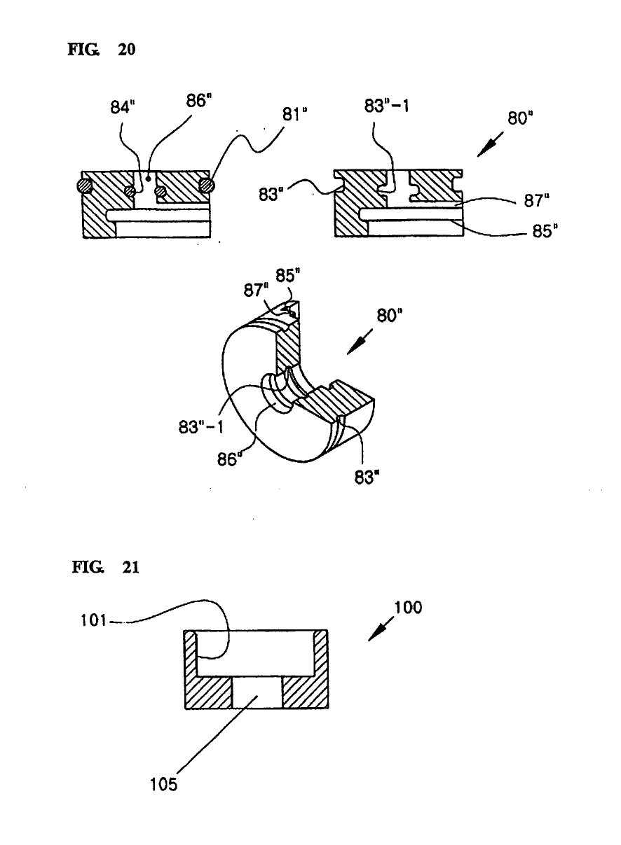

FIG. 21 is the sectional view that shows rod guide when it comes to this invention.

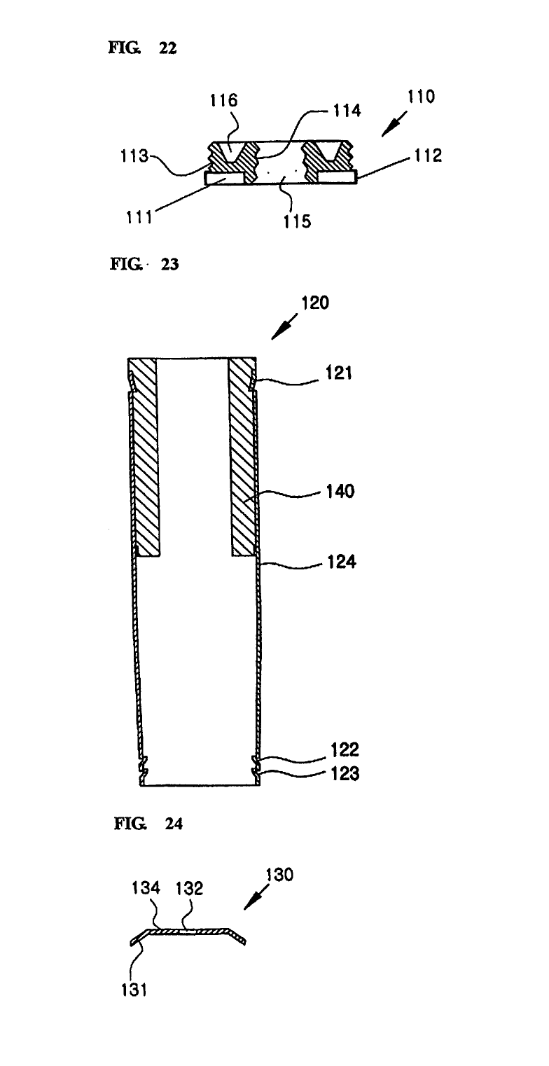

FIG. 22 is the sectional view that shows sectional view that shows rod seal when it comes to this invention.

FIG. 23 is the outer drum when it comes to this invention.

FIG. 24 is the sectional view that shows spindle support when it comes to this invention.

The following are shown; cylinder (30), sloped side (31), end part of the upper side (32), end part of the lower side (33), boundary side (34), inner side (35,35-1), pass-through hole at the upper part (36), pass-through hole at the lower part (37), cylinder surface (38), sloped side (39), push bar (40), small diameter surface (41), rectangular gap surface (42), large diameter surface (43), inner side of the central groove part (44), end part of the groove part (45), central groove (46), pass-through hole (47), push support (50), pass-through hole (51), insertion part (52), suspension sill (53), valve seal (60), seal lip (61,62), surface (63,64,65), space surface (66,68), pass-through hole (67), surface of sloped part (69), pipe for gas transport (70,70′,70″,70*), end part of the upper part (71,71′,7111,71*), gas transport hole (72,72′, 72″,72*), passageway for gas transport (73,73′,73″,73*), end part of the lower side (74,74′,74″,74*), swelled oval spherical surface (75″,75*), gas sealing hole (76″,76*,77″,77*), push pin (78″,78*), projected part (78″-1, 78″-2,78*-1,78*-2), metallic bar (79,79″,79′-1,79′-2,79*-1,79*-2), piston (80,80′, 80″), double seal lip (81,81-1, 84,84-1), O-ring (81′,81″,84′,84″), inner diameter part (82), groove (82′, 83′,83′-1,83″,83″-1,85″), hole (86,86′,86″), metallic core material (87), gas transport groove (87″), metallic core material surface (88), projected part (89), piston rod (90), fixation board (91), end part of the upper part (91′) that is projected in the form of radial that is inserted into the groove (85″) at the side of the piston (80″)'s lower part by being formed on the above mentioned piston rod (90′) is comprised of upper part, surface of upper part (92), inner groove (92′), rod for lower side conjoining (93′), part of lower side (94′), surface of the middle part (95,95′), surface of lower part (96), side of small diameter part (96′), groove (97,97′), gas sealing elastic entity (98′), conjoining projection (99′), rod guide (100), inner side of circumference (101), center hole (105), rod seal (110), metallic core material (11), outer side of circumference (12), seal lip (113,114), center hole (115), groove (116), outer drum (120), projected outward projection (121,122,123), spindle support (130), sloped part (131), hole (132), surface of the center part (134), slide supplementary material (140), retainer (150), clip (160), vibration-proof rubber (170), round shape (R′,R*), X chamber room (X), and Y chamber room (Y).

FIG. 4 is the vertical sectional view that shows length adjustable gas spring of this invention.

cylinder shaped outer drum (120); spindle support (130) that is inserted and conjoined onto the lower part of the inner side of the above mentioned outer drum (120); slide supplementary material (140) that is comprised by being injected at the upper part of the above mentioned outer drum (120)'s inner side; cylinder (30) of single cylinder structure that is supported through the above mentioned slide supplementary material (140) after being inserted to the above mentioned outer drum (120); push support (50) comprised at the upper part of the above mentioned cylinder (30)'s inner side; push bar (40) of synthetic resin material that is comprised after being projected towards the outer side of the above mentioned cylinder (30) after being inserted into the above mentioned push support (50); valve seal (60) of rubber material and elastic entity that is comprised at the lower part of the above mentioned push support (50); piston (80) of elastic entity and rubber material that is comprised at the center of the above mentioned cylinder (30)'s inner side; rod seal (110) of rubber and elastic entity material that is comprised at the lower part of the above mentioned cylinder (30)'s inner side; rod guide (100) of synthetic resin material that is comprised at the upper part of the above mentioned rod seal (110); retainer (150) that is comprised at the upper part of the above mentioned spindle support (130); vibration-proof rubber (170) that mitigates the shock of cylinder (30) that moves up and down after being comprised at the upper part of the above mentioned retainer (150); piston rod (90) that is fixated onto the lower part of the above mentioned spindle support (130) by clip (160) and that passes through the above mentioned rod guide (100) and rod seal (110) by being conjoined onto the above mentioned piston (80); and pipe for gas transport (70) of synthetic resin or metallic material that is inserted to the push bar (40) by passing through the piston (80), valve seal (60) and push support (50) that are comprised at the center and upper part of the above mentioned cylinder (30)'s inner side.

As shown on FIG. 8, the above mentioned cylinder (30) is comprised of; pass-through hole of the upper and lower part (36,37) that is formed at the upper and lower part; end part of the upper side (32) that is formed to bend towards the inner side and that is formed at the end part of the upper side; sloped side (31) that is conjoined with chair's upper board by being formed in a way that it is sloped at the lower part of the above mentioned end part of the upper side (32) formed angle with a degree of 1, 26 minutes and 16 seconds; cylinder surface (38) formed at the lower part of the above mentioned sloped side (31); end part of the lower side (33) that is formed to suit curling work by being formed smaller than the measurement of outer diameter of the cylinder surface (38) and that is formed at the lower part of the above mentioned cylinder surface (38); boundary side (34) that is formed between the above mentioned inner side (35-1) of the end part of the above mentioned lower side and inner side (35) of cylinder as slightly projected upward projection in the form of a slope and that is set larger than the inner diameter of cylinder's inner side (35) when it comes to the inner side (35-1) of the end part of the above mentioned lower side, and sloped side (39) that bends into rectangular to prevent separation after injecting the above mentioned components and that facilitates the injection of the above mentioned push support (50), valve seal (60), piston (80,80′,80″), rod guide (100) and rod seal (110) by being injected at the lowest part. Metallic core material outer side of circumference (12) of rod seal (110) is injected and tightened in the boundary side (34) formed as slightly projected upward projection in the shape of a slope. Movement of rod seal (110) towards the inner side of the cylinder (30) is prevented due to the pressure of gas that is injected at the inside of the cylinder (30).

As shown on FIG. 9, the above mentioned push bar (40) is in the shape of a rod, and it formed with pass-through hole (47) formed at the center part; central groove (46) where the above mentioned pipe for gas transport (70)'s end part of the upper part is inserted and that is formed at the lower part of the above mentioned pass-through hole (47); and rectangular gap surface (42) formed between small diameter surface (41) of the outer side and large diameter side (43) to prevent the separation from the push support (50). 3.0 mm˜7.0 mm is appropriate for the inner diameter of the above mentioned central groove (46)'s inner side of the central groove part (44). 1.5 mm˜3.5 mm is appropriate for the radius of the round end part of the groove part (45) that is formed at the upper part of the above mentioned inner side of the central groove part (44).

As shown on FIG. 10, the above mentioned push support (50) is included at the upper part of the cylinder (30)'s inner side. It is formed in the center in the shape of a cylinder, and is comprised of; pass-through hole (51) for injecting the above mentioned push bar (40), suspension sill (53) that is formed around the upper part of the above mentioned pass-through hole (51) and that prevents the separation of the above mentioned push bar (40); and insertion part (52) that is formed at the lower part to conjoin with valve seal (60).

As shown on FIG. 11, the above mentioned valve seal (60) is dynamic pressure seal of the ring shape that is formed with pass-through hole (67) formed at the center; seal lip (61,62) formed three to five each at the outer side of circumference and inner side of circumference; space side (66) that is formed between the above mentioned outer side of circumference and inner side of circumference seal lip (61,62) into side (63), side (64) and side (65)'s mutually rectangular shape and where the insertion part (52) of the above mentioned push support (50) is inserted by being attached closely; space side (68) that has surface of sloped part (69) in order to increase sealing ability due to gas pressure at the inside of the above mentioned cylinder (30) and that is formed at the lower side between the above mentioned seal lip (61,62).

Numerous seal lips (62) at the inner side of circumference increases endurance and that minimizes the friction at the time of movement and gyration of pipe for gas transport (70) between the pass-through hole (67) that is formed at the inner side of circumference.

Gas sealing ability is increased since numerous seal lips (61) of the above mentioned outer side of circumference is closely attached to the inner side of the cylinder (30).

As shown on FIG. 12, the above mentioned pipe for gas transport (70) is cylinder pipe that is formed into straight or curved line of 2.5 mm ˜7.0 mm in outer diameter. It is comprised of; passageway for gas transport (73) formed with 1.0 mm˜5.5 mm in inner diameter at the center; end part (71) that is comprised into tightened side formed at the end part of the upper part at a radius of 1.5 mm˜3.5 mm when it comes to curved part, gas transport hole (72) that is formed into the size of 0.5 mm˜3.5 mm in terms of inner diameter at the side of the lower part of the from the above mentioned end part (71) (straight line of 10 mm˜40 mm); end part of the lower side (74) that is formed in the shape of a horn towards the outer side of the end part of the lower side and that prevents separation when inserted into the piston (80); and metallic bar (79) that is included and inserted at the inside to complement the weakness of bending easily when the material is made of synthetic resin.

As shown on FIG. 18, the above mentioned piston (80) is comprised of; inner diameter part (82) that is formed at the center and that is riveted by being inserted with the surface of upper part (92) of the above mentioned piston rod (90); projected part (89) that is formed to project out towards the upper and lower side at the end part of both sides of the above mentioned inner diameter part (82); metallic core material (87) that is formed at the center; radial type of double seal lip (81,81-1) that is formed by being projected out onto the outer side of circumference by forming an acute angle with side (88) of the above mentioned metallic core material (87); hole (86) where the above mentioned pipe for gas transport (70) goes through by being formed between the outer side of circumference and inner diameter part (82) formed with the above mentioned radial type of double seal lip (81,81-1), and double seal lip (84,84-1) for the sealing of gas between the pipe for gas transport (70) and hole (86) by being formed in the same structure and shape as that of double seal lip (81,81-1) of the above mentioned outer side of circumference into the inner side radial type of direction at the inside of the above mentioned hole (86).

Double seal lip (81,84) of the upper side plays the main role of sealing gas if and when the gas pressure in the Y chamber room (Y) is higher than that of the X chamber room (X). On the contrary, double seal lip (81-1,84-1) of the lower side plays the main role of sealing gas if and when the gas pressure of the Y chamber room (Y) is lower than that of the X chamber room (X).

As shown on FIG. 16, the above mentioned piston rod (90) is formed with surface of upper part (92) that is fixated into round shaped fixation board (91) by being input into the inner diameter part (82) of the above mentioned piston (80) by being formed at the upper part; surface of lower part (96) that is formed to enable the above mentioned retainer (150) and spindle support (130) to be inserted and that is formed at the lower part; surface of the middle part (95) that is inserted into the above mentioned rod guide (100), rod seal (110), cylinder (30)'s pass-through hole at the lower part (37) and vibration-proof rubber (170) and that is formed between the above mentioned surface of upper part (92) and surface of lower part (96); boundary side (93,94) in which the boundary part of the above mentioned upper, surface of lower part (92,96) and surface of the middle part (95) are each comprised of rectangular gap; and the groove (97) that is formed so that the above mentioned clip (160) can be inserted and that is formed at the lower part of the above mentioned surface of lower part (96).

As shown on FIG. 21, the above mentioned rod guide (100) is formed with inner side of circumference (101) of the cylinder shape that is formed inside the upper side; and center hole (105) that goes through the piston rod (90) that is formed at the center part.

As shown on FIG. 22, the above mentioned rod seal (110) is comprised of; center hole (115) that is formed at the center; seal lip (113,114) that increases the ability to tighten gas by minimizing friction ability and that is configured into 3 to 5 layers at the outer side of circumference and inner side of circumference; groove (116) that is formed between the above mentioned seal lip (113,114); and metallic core material (111) that is composed in a way that the outer side of circumference (112) cannot move to the inner direction of the cylinder by the slightly projected upward projection boundary side (34) of the above mentioned cylinder (30) at the time of injecting high pressure gas by maintaining round shape under the high gas pressure by being included at the floor, making the outer diameter of the outer side of circumference (112) is made similar to the inner diameter of the inner side of the lower part's end part when it comes to the cylinder (30), and making it larger than the inner side of cylinder (35).

As shown on FIG. 23, slide supplementary material (140) made of synthetic resin is injected in the upper part of the inner side when it comes to the outer drum (120). After its composition, at least one projection (121) is included at the inner side of the upper part to prevent separation. Moreover, at least two projections (123) was formed towards the inner direction at the tapered end part of the lower side part so that it will be symmetrical, both on the left and right side. At least two projections (122) are formed at the 1 mm˜3 mm upward from the above mentioned projection (123). And spindle support (130) is placed and fixated between the above mentioned projections (122,123) without welding.

As shown on FIG. 24, the above mentioned spindle support (130) is conjoined by being inserted to the projection (122,123) formed at the end part of the lower side of the above mentioned outer drum (120) towards the inner direction. To support weight of least 250 Kg, it shows length adjustable gas spring that is formed with surface of the center part (134) of the rounded board; sloped part (131) that is formed to slope to specific angle towards the outer side of the above mentioned surface of the center part (134); and hole (132) where the lower part of the piston rod (90) that is at the center of the above mentioned surface of the center part (134) penetrates through.

When it relates to the up/down movement process, if and when the push bar (40) is pressed with a force that is at least 4 Kg at a state when the gas is inside the cylinder (30) with fixed pressure, pipe for gas transport (70) moves towards the “A” direction. Gas transport hole (72) that is at the upper side of the pipe for gas transport (70) moves to the Y chamber room (Y) from the center of the valve seal (60)'s inner side of circumference (62). Gas in the X chamber room (X) moves to the Y chamber room (Y) through passageway for gas transport (73) and gas transport hole (72). Accordingly, piston rod (90) moves to the “A” direction, and cylinder (30) increases towards the “B” direction due to opposing reaction since piston rod (90) is fixed onto the spindle support (130) that is inserted onto the outer drum (120) by the clip (160).

Moreover, if and when the external force that presses down on the push bar (40) is removed, pipe for gas transport (70) moves to the “B” direction by leveraging its own force due to the pressure of the gas of the X chamber room (X) at the inside of cylinder (30). Accordingly, gas transport hole (72) of pipe for gas transport (70) moves to the center hole (67) at the inside of the valve seal (60). Since the pass-through hole of the gas transport hole (72) is tightened, movement of gas between X chamber room (X) and Y chamber room (Y) stops, and the piston rod (90) stops to move. Accordingly, cylinder (30) stops to increase to the “B” direction.

FIG. 5 is the vertical sectional view that shows another length adjustable gas spring of this invention.

Its structure is the same as the above mentioned FIG. 4, and its composition is based on the replacement of pipe for gas transport (70) and piston (80) with pipe for gas transport (70*) and piston (80′) of another form.

As shown on FIG. 15, the above mentioned pipe for gas transport (70*) is at the center line level of the collection of spring type of pipe as straight line pipe from the end part of the upper part (71*) to the 15 mm 50 mm as shown on FIG. 15. Later, straight line pipe of 5 mm˜10 mm forms rectangular with the center line of collection of spring type of pipe. Later, it is on the collection of spring type of pipe round shape (R*) level. From the end part of the lower side (74*) to the 10 mm˜20 mm of the upper side, it is formed in the shape of straight line pipe that goes in parallel with the center line of the collection of spring type of pipe. It is comprised of; end part of the upper part (71*) that is comprised of 1.5 mm˜3.5 mm radius of curved part that is formed at the end part of the upper part; passageway for gas transport (73*) of 1.5 mm˜5.5 mm of inner diameter that is formed at the center of the inside; push pin (78*) that is included at the upper part of the above mentioned passageway for gas transport (73*); hole shaped gas sealing hole (76*,77*) that is formed at the end part of the lower part and the center of the above mentioned push pin (78*); projected part (78*-1,78*-2) for the prevention of separation that prevents separation of the gas sealing hole (76*,77*) by being formed at the center of the above mentioned push pin (78*) and end part of the lower side; gas transport hole (72*) of 0.5 mm 3.5 mm inner diameter that is formed between gas sealing hole (76*,77*) after being formed at 15 mm˜40 mm of the lower part from the above mentioned end part of the upper part (71*); swelled oval spherical surface (75*) of oval shape that is formed 5 m˜15 mm below the above mentioned gas transport hole (72*); collection of spring type of pipe round shape (R*) that is formed at the lower part of the above mentioned swelled oval spherical surface (75*); metallic bar (79*-1,79*-2) that is formed from the one side of collection of spring type of pipe round shape (R*)'s lower part to the end part of the lower part and from the lower part of the above mentioned swelled oval spherical surface (75*) to the one side of the above mentioned collection of round shaped spring type of pipe (R*)'s upper part in order to prevent the twisting and transmutation of the above mentioned collection of spring type of pipe round shape (R*); and end part of the lower side (74*) formed with horn shaped open side at the end part of the lower part to prevent the separation from the above mentioned piston (80′).

As shown on the FIG. 19, the above mentioned piston (80′) depicts length adjustable gas spring that forms groove (83′) inserted with O-ring (81′) that is comprised of elastic entity that tightens gas by being formed at the outer side of circumference of the upper part; groove (82′) that is formed in a way that the piston rod (90) is fixed based on the insertion of end part of the upper part (91) that is formed by riveting piston rod surface of upper part (92) of the small diameter of the piston rod (90) by being formed to approximately to 7/10 location of the piston's diameter from the side of the lower part; hole (86′) where the above mentioned pipe for gas transport (70*) penetrates by being formed between the above mentioned groove (82′) and outer side of circumference; and groove (83′-1) that is inserted with the O-ring (84′) that is made of elastic entity at the inside of the hole (86′) for the sealing of gas between the above mentioned pipe for gas transport (70*) and hole (86′).

When it relates to the up/down movement process, if and when the push pin (78*) is pressed with a force that is at least 0.3 Kg at a state when the gas is inside the cylinder (30) with fixed pressure, gas sealing hole (77*) at the lower part of the push pin (78*) moves towards the “A” direction, and is situated at the center part of the inside of swelled oval spherical surface (75*) of pipe for gas transport (70*) to penetrate through. Accordingly, gas of the X chamber room (X) moves from the X chamber room (X) to Y chamber room (Y) through passageway for gas transport (73*) and gas transport hole (72*). Piston rod (90) moves to the “A” direction, and cylinder (30) increases towards the “B” direction due to opposing reaction since piston rod (90) is fixed onto the spindle support (130) that is inserted onto the outer drum (120) by the clip (160).

Moreover, if and when the external force that presses the push pin (78*) is removed, gas sealing hole (77*) at the lower part of the push pin (78*) moves towards the “B” direction at the upper part of the swelled oval spherical surface (75*) due to the pressure of the gas of the X chamber room (X) that is at the inside of cylinder (30). As such, passing through of pipe for gas transport (70*)'s passageway for gas transport (73*) is blocked, which in turn stops the transportation of gas between X chamber room (X) and Y chamber room (Y). As a result, piston rod (90) stops to move and cylinder (30) stops increase into the “B” direction.

FIG. 6 is the vertical sectional view that shows yet another length adjustable gas spring of this invention.

Its structure is the same as the above mentioned FIG. 4, and its composition is based on the replacement of pipe for gas transport (70), piston (80) and piston rod (90) with gas transport (70′), piston (80″) and piston rod (90′) of another form.

As shown on FIG. 13, the above mentioned pipe for gas transport (70′) is at the center line level of the collection of spring type of pipe as straight line pipe from the end part of the upper part (71′) to the 15 mm 50 mm. Later, straight line pipe of 5 mm˜10 mm forms rectangular with the center line of collection of spring type of pipe. Later, it is on the collection of spring type of pipe round shape (R′) level. From the end part of the lower side (74′) to the 10 mm˜20 mm of the upper side, it is formed in the shape of straight line pipe that goes in parallel with the center line of the collection of spring type of pipe.

It is comprised of; end part of the upper part (71′) that is comprised of 1.5 mm˜3.5 mm radius of curved part that is formed at the end part of the upper part; passageway for gas transport (73′) of 1.5 mm˜5.5 mm of inner diameter that is formed at the center of the inside; gas transport hole (72′) of 0.5 mm˜3.5 mm in inner diameter and that is formed from the above mentioned end part of the upper part (71′) to the 15 mm˜40 mm lower part; collection of round shaped spring type of pipe (R′) formed at the lower part of the above mentioned gas transport hole (72′); metallic bar (79′-1,79′-2) that is formed from the one side of collection of spring type of pipe round shape (R′)'s lower part to the end part of the lower part and from the lower part of the above mentioned end part of the upper part (71′) to the one side of the above mentioned collection of round shaped spring type of pipe (R′)'s upper part in order to prevent the twisting and transmutation of the above mentioned collection of spring type of pipe round shape (R′); and end part of the lower side (74′) formed with horn shaped open side at the end part of the lower part to prevent the separation from the above mentioned piston (80″).

From the upper part to the side, approximately 8/10 location of piston's diameter is formed, and it is formed of groove (85″) that is fixed by being inserted with the above mentioned piston rod (90′)'s radial type of end part of the upper part (91′) that is projected in the form of radial that is inserted into the groove (85″) at the side of the piston (80″)'s lower part by being formed on the above mentioned piston rod (90′) is comprised of upper part; and gas transport groove (87″) that is formed to move between X chamber room (X) at the center of the above mentioned groove (85″)'s upper side and piston rod (90′)'s inner groove (92′).

As shown on the FIG. 20, the above mentioned piston (80″) depicts length adjustable gas spring that forms groove (83″) inserted with O-ring (81″) that is comprised of elastic entity that tightens gas by being formed at the outer side of circumference of the upper part; hole (86″) where the above mentioned pipe for gas transport (70′) or pipe for gas transport (70″) penetrates through; groove (83″-1) that is inserted with the O-ring (84″) that is made of elastic entity at the inside of the hole (86″) for the sealing of gas between the above mentioned pipe for gas transport (70′) or gas transport (70″) and hole (86″); and groove (82′) that is formed in a way that the piston rod (90) is fixed based on the insertion of end part of the upper part (91) that is formed by riveting piston rod surface of upper part (92) of the small diameter of the piston rod (90) by forming to approximately 8/10 location of the piston's diameter from the side of the lower part.

As shown on FIG. 17, the above mentioned piston rod (90′) is comprised of end part of the upper part (91′) that is projected in the form of radial that is inserted into the groove (85″) at the side of the piston (80″)'s lower part by being formed on the above mentioned piston rod (90′) is comprised of upper piston rod (90′) is comprised of upper part; part of lower side (94′) that is bent towards the inner side in the form of radial at the lower part; inner groove (92′) where the gas sealing elastic entity (98′) and rod for lower side conjoining (93′) are inserted by being formed at the inside of the center; and piston rod surface (95′) that assumes large diameter part that moves two-way by contacting with the inner side of circumference seal lip (114) of the rod seal (110) by being formed between the above mentioned end part of the upper part (91′) that is projected in the form of radial that is inserted into the groove (85″) at the side of the piston (80″)'s lower part by being formed on the above mentioned piston rod (90′) is comprised of upper part and part of lower side (94′).

This depicts yet another length adjustable gas spring that forms conjoining projection (99′) for the prevention of separation by being fixated onto the above mentioned part of lower side (94′) when it comes to the upper part of rod for lower side conjoining (93′) that is inserted and conjoined with the above mentioned inner groove (92′); side of small diameter part (96′) that is inserted into vibration-proof rubber (170), retainer (150) and spindle support (130) by being formed at the lower part of the above mentioned conjoining projection; and groove (97′) where the clip (160) is inserted by being formed at the lower part of the above mentioned side of small diameter part (96′).

When it relates to the up/down movement process, if and when the push bar (40) is pressed with a force that is at least 4 Kg at a state when the gas is inside the cylinder (30) with fixed pressure, pipe for gas transport (70′) moves towards the “A” direction. Gas transport hole (72′) that is at the upper side of the pipe for gas transport (70′) moves to the Y chamber room (Y) from the center of the valve seal (60)'s inner center hole (67). Gas in the X chamber room (X) moves to the Y chamber room (Y) through gas passageway (87″) of piston (80″), inner groove (92′) at the inside of piston rod (90′)'s center, passageway for gas transport (73′) and gas transport hole (72′). Accordingly, piston rod (90′) moves towards the “A” direction, and cylinder (30) increases towards the “B” direction due to opposing reaction since piston rod (90′) is fixed onto the spindle support (130) that is inserted onto the outer drum (120) by the clip (160).

Moreover, if and when the external force that presses down on the push bar (40) is removed, pipe for gas transport (70′) moves to the “B” direction by leveraging its own force due to the pressure of the gas of the X chamber room (X) at the inside of cylinder (30). Accordingly, gas transport hole (72′) of pipe for gas transport (70′) moves to the center hole (67) at the inside of the valve seal (60). Since the pass-through hole of the gas transport hole (72′) is tightened, movement of gas between X chamber room (X) and Y chamber room (Y) stops, and the piston rod (90′) stops to move. Accordingly, cylinder (30) stops to increase to the “B” direction.

FIG. 7 is the vertical sectional view that shows yet another length adjustable gas spring of this invention.

Its structure is the same as the above mentioned FIG. 6, and its composition is based on the replacement of pipe for gas transport (70′) with pipe for gas transport (70″) of another form.

As shown on FIG. 14, he above mentioned pipe for gas transport (70″) forms end part of the upper part (71″) that is comprised of 1.5 mm˜3.5 mm radius of curved part that is formed at the end part of the upper part; passageway for gas transport (73″) of 1.0 mm˜5.5 mm in terms of inner diameter that is formed at the center of the inside; push pin (78″) that is included at the upper part of the above mentioned passageway for gas transport (73″); gas sealing hole (76″,77″) of hole shape that is formed at the end part of the lower side and the center of the above mentioned push pin (78″); projected part (78″-1,78*-2) for the prevention of separation that prevents the separation of the gas sealing hole (76″,77″) by being formed at the center of the above mentioned push pin (78″) and end part of the lower side; gas transport hole (72″) of 0.5 mm˜3.5 mm in inner diameter that is formed between the above mentioned gas sealing holes (76″,77″) by being formed at the side of the 10 mm˜40 mm lower part from the above mentioned end part of the upper part (71″); swelled oval spherical surface (75″) of oval hole shape that is formed 5 mm˜15 mm below the above mentioned gas transport hole (72″); end part of the lower side (74″) where horn shaped open side is formed at the end part of the lower part to prevent separation from the above mentioned piston (80″); and metallic bar (79″) that prevents transmutation by being formed up to the area near the end part of the lower side (74″) from the lower part of the above mentioned swelled oval spherical surface (75″).

When it relates to the up/down movement process, if and when the push pin (78″) is pressed with a force that is at least 0.3 Kg at a state when the gas is inside the cylinder (30) with fixed pressure, gas sealing hole (77″) at the lower part of the push pin (78″) moves towards the “A” direction, and is situated at the center part of the inside of swelled oval spherical surface (75*) of pipe for gas transport (70*) to penetrate through. Accordingly, gas of the X chamber room (X) moves from the X chamber room (X) to Y chamber room (Y) through passageway for gas transport (73*) and gas transport hole (72*). Piston rod (90) moves to the “A” direction, and cylinder (30) increases towards the “B” direction due to opposing reaction since piston rod (90) is fixed onto the spindle support (130) that is inserted onto the outer drum (120) by the clip (160).

Moreover, if and when the external force that presses the push pin (78″) is removed, gas sealing hole at the lower part of the push pin (78″) moves towards the “B” direction at the upper part of the swelled oval spherical surface (75″) due to the pressure of the gas of the X chamber room (X) that is at the inside of cylinder (30). As such, passing through of pipe for gas transport (70′)'s passageway for gas transport hole (72″) is blocked, which in turn stops the transportation of gas between X chamber room (X) and Y chamber room (Y). As a result, piston rod (90″) stops to move and cylinder (30) stops increase into the “B” direction.

As mentioned above, this invention enables appropriate combination and production of the above mentioned pipe for gas transport (70,70′,70″,70*), piston (80,80′,80″) and piston rod (90,90′) for use.

What is claimed is:

1. Length Adjustable Gas Spring characterized by the following composition; cylinder shaped outer drum (120); spindle support (130) that is comprised at the lower part of the above mentioned outer drum (120)'s inner part; slide supplementary material (140) that is comprised by being injected at the upper part of the above mentioned outer drum (120)'s inner side; cylinder (30) of single cylinder structure that is supported through the above mentioned slide supplementary material (140) after being inserted to the above mentioned outer drum (120); push support (50) comprised at the upper part of the above mentioned cylinder (30)'s inner side; push bar (40) of synthetic resin material that is comprised after being projected towards the outer side of the above mentioned cylinder (30) after being inserted into the above mentioned push support (50); valve seal (60) of rubber material and elastic entity that is comprised at the lower part of the above mentioned push support (50); piston (80,80′,80″) of rubber material and elastic entity that is comprised at the center of the above mentioned cylinder (30)'s inner side; rod seal (110) of rubber and elastic entity material that is comprised at the lower part of the above mentioned cylinder (30)'s inner side; rod guide (100) of synthetic resin material that is comprised at the upper part of the above mentioned rod seal (110); retainer (150) that is comprised at the upper part of the above mentioned spindle support (130); vibration-proof rubber (170) that mitigates the shock of cylinder (30) that moves up and down after being comprised at the upper part of the above mentioned retainer (150); piston rod (90,90′) that is fixated onto the lower part of the above mentioned spindle support (130) by clip (160) and that passes through the above mentioned rod guide (100) and rod seal (110) by being conjoined onto the above mentioned piston (80,80′,80″); and pipe for gas transport (70,70′,70″,70*) of synthetic resin or metallic material that is inserted to the push bar (40) by passing through the piston (80,80′,80″), valve seal (60) and push support (50) that are comprised at the center and upper part of the above mentioned cylinder (30)'s inner side.

2. When it relates to claim 1, length adjustable gas spring that is characterized by the following; the above mentioned cylinder (30) is comprised of pass-through hole at the upper and lower part (36,37) that is formed at the upper and lower part; end part of the upper side (32) that is formed to bend towards the inner side and that is formed at the end part of the upper side; sloped side (31) that is conjoined with chair's upper board by being formed in a way that it is sloped at the lower part of the above mentioned end part of the upper side (32); cylinder surface (38) formed at the lower part of the above mentioned sloped side (31); end part of the lower side (33) that is formed to suit curling work by being formed smaller than the measurement of outer diameter of the cylinder surface (38) and that is formed at the lower part of the above mentioned cylinder surface (38); boundary side (34) that is formed between the above mentioned inner side (35-1) of the end part of the above mentioned lower side and inner side of cylinder (35) as slightly projected upward projection in the form of a slope and that is set larger than the inner diameter of cylinder's inner side (35) when it comes to the inner side (35-1) of the end part of the above mentioned lower side, and sloped side (39) that bends into rectangular to prevent separation after injecting the above mentioned components and that facilitates the injection of the above mentioned push support (50), valve seal (60), piston (80,80′,80″), and rod guide (100) and rod seal (110) by being injected at the lowest part Metallic core material outer side of circumference (112) of rod seal (110) is injected and tightened in the boundary side (34) formed as slightly projected upward projection in the shape of a slope. Movement of rod seal (110) towards the inner side of the cylinder (30) is prevented due to the pressure of gas that is injected at the inside of the cylinder (30).

3. When it relates to claim 1, length adjustable gas spring is characterized by; the above mentioned push bar (40) is in the shape of a rod, and it formed with pass-through hole (47) formed at the center part; central groove (46) where the above mentioned pipe for gas transport (60)'s end part of the upper part is inserted and that is formed at the lower part of the above mentioned pass-through hole (47); and rectangular gap surface (42) formed between small diameter surface (41) of the outer side and large diameter side (43) to prevent the separation from the push support (50).

4. When it relates to claim 1, length adjustable gas spring is characterized by; push support (50) is included at the upper part of the cylinder (30)'s inner side. It is formed in the center in the shape of a cylinder, and is comprised of; pass-through hole (51) for injecting the above mentioned push bar (40), suspension sill (53) that is formed around the upper part of the above mentioned pass-through hole (51) and that prevents the separation of the above mentioned push bar (40); and insertion part (52) that is formed at the lower part to conjoin with valve seal (60).

5. When it relates to claim 1, length adjustable gas spring is characterized by; the above mentioned valve seal (60) is dynamic pressure seal of the ring shape that is formed with pass-through hole (67) formed at the center; seal lip (61,62) formed three to five each at the outer side of circumference and inner side of circumference; space side (66) that is formed between the above mentioned outer side of circumference and inner side of circumference seal lip (61,62) into side (63), side (64) and side (65)'s mutually rectangular shape and where the insertion part (52) of the above mentioned push support (50) is inserted by being attached closely; space side (68) that has surface of sloped part (69) in order to increase sealing ability due to gas pressure at the inside of the above mentioned cylinder (30) and that is formed at the lower side between the above mentioned seal lip (61,62).
Numerous seal lips (62) at the inner side of circumference increases endurance and that minimizes the friction at the time of movement and gyration of pipe for gas transport (70) between the pass-through hole (67) that is formed at the inner side of circumference.
Gas sealing ability is increased since numerous seal lips (61) of the above mentioned outer side of circumference is closely attached to the inner side of the cylinder (30).

6. When it relates to claim 1, length adjustable gas spring characterized by; the above mentioned pipe for gas transport (70) is cylinder pipe that is formed into straight line or curved line, and it is comprised of passageway for gas transport (73) that is formed at the center of the inside, end part (71) that is comprised at the end part of the upper part in the form of tightened side; gas transport hole (72) that is formed at the side of the lower part of the end part (71); end part of the lower side (64) that prevents separation when injected into the piston (80) by being formed into the shape of a horn towards the outer side of the end part of the lower side; and metallic bar (79) that is composed by injecting into the interior.

7. When it relates to claim 1, length adjustable gas spring is characterized by; end part of the upper part (71′) formed at the end part of the upper part when it relates to the above mentioned pipe for gas transport (70′); passageway for gas transport (73′) formed at the center of the inside; gas transport hole (72′) that is formed at the side of the lower part of the above mentioned end part of the upper part (71′); collection of round shaped spring type of pipe (R′) formed at the lower part of the above mentioned gas transport hole (72′); metallic bar (79′-1,79′-2) that is formed from the one side of collection of spring type of pipe round shape (R*)'s lower part to the end part of the lower part and from the lower part of the above mentioned end part of the upper part (71′) to the one side of the above mentioned collection of round shaped spring type of pipe (R′)'s upper part in order to prevent the twisting and transmutation of the above mentioned collection of spring type of pipe round shape (R′); and end part of the lower side (74′) formed with horn shaped open side at the end part of the lower part to prevent the separation from the above mentioned piston (80″).

8. When it relates to claim 1, length adjustable gas spring is characterized by; the above mentioned pipe for gas transport (70″) forms end part of the upper part (71″); passageway for gas transport (73″) that is formed at the center of the inside; push pin (78″) that is included at the upper part of the above mentioned passageway for gas transport (73″); gas sealing hole (76″,77″) of hole shape that is formed at the end part of the lower side and the center of the above mentioned push pin (78″); projected part (78″-1,78*-2) for the prevention of separation that prevents the separation of the gas sealing hole (76″,77″) by being formed at the center of the above mentioned push pin (78″) and end part of the lower side; gas transport hole (72″) that is formed between the above mentioned gas sealing holes (76″,77″); swelled oval spherical surface (75″) of oval hole shape that is formed below the above mentioned gas transport hole (72″); end part of the lower side (74″) where horn shaped open side is formed at the end part of the lower part to prevent separation from the above mentioned piston (80″); and metallic bar (79″) that prevents transmutation by being formed up to the area near the end part of the lower side (74″) from the lower part of the above mentioned swelled oval spherical surface (75″).

9. When it relates to claim 1, length adjustable gas spring characterized by; the above mentioned pipe for gas transport (70*) forms end part of the upper part (71*); passageway for gas transport (73*) that is formed at the center of the inside; push pin (78*) that is included at the upper part of the above mentioned passageway for gas transport (73*); gas sealing hole (76*,77*) of hole shape that is formed at the end part of the lower side and the center of the above mentioned push pin (78*); projected part (78*-1,78*-2) for the prevention of separation that prevents the separation of the gas sealing hole (76″,77″) by being formed at the center of the above mentioned push pin (78*) and end part of the lower side; gas transport hole (72*) that is formed between the above mentioned gas sealing holes (76*,77*); swelled oval spherical surface (75*) of oval hole shape that is formed below the above mentioned gas transport hole (72*); end part of the lower side (74″) where horn shaped open side is formed at the end part of the lower part to prevent separation from the above mentioned piston (80″); and metallic bar (79″) that prevents transmutation by being formed up to the area near the end part of the lower side (74″) from the lower part of the above mentioned swelled oval spherical surface (75″).

10. When it relates to claim 1, length adjustable gas spring characterized by; inner diameter part (82) that is formed at the center and that is riveted by being inserted with the upper part of the above mentioned piston rod (90); projected part (89) that is formed to project out towards the upper and lower side at the end part of both sides of the above mentioned inner diameter part (82); metallic core material (87) that is formed at the center; radial type of double seal lip (81,81-1) that is formed by being projected out onto the outer side of circumference by forming an acute angle with side (88) of the above mentioned metallic core material (87); hole (86) where the above mentioned pipe for gas transport (70) goes through by being formed between the outer side of circumference and inner diameter part (82) formed with the above mentioned radial type of double seal lip (81,81-1), and double seal lip (84,84-1) for the sealing of gas between the pipe for gas transport (70) and hole (86) by being formed in the same structure and shape as that of double seal lip (81,81-1) of the above mentioned outer side of circumference into the inner side radial type of direction at the inside of the above mentioned hole (86).
Double seal lip (81,84) of the upper side plays the main role of sealing gas if and when the gas pressure in the Y chamber room (Y) is higher than that of the X chamber room (X). On the contrary, double seal lip (81-1,84-1) of the lower side plays the main role of sealing gas if and when the gas pressure of the Y chamber room (Y) is lower than that of the X chamber room (X).

11. When it relates to claim 1, the above mentioned piston (80) as it relates to the length adjustable gas spring is characterized by; groove (83′) inserted with O-ring (81′) that is comprised of elastic entity that tightens gas by being formed at the outer side of circumference of the upper part; groove (82′) that is formed in a way that the piston rod (90) is fixed based on the insertion of end part of the upper part (91) that is formed by riveting piston rod surface of upper part (92) of the small diameter of the piston rod (90) by being formed to approximately to 7/10 point of the piston's diameter from the side of the lower part; hole (86′) where the above mentioned pipe for gas transport (70*) penetrates by being formed between the above mentioned groove (82′) and outer side of circumference; and groove (83′-1) that is inserted with the O-ring (84′) that is made of elastic entity at the inside of the hole (86′) for the sealing of gas between the above mentioned pipe for gas transport (70*) and hole (86′).

12. When it relates to claim 1, length adjustable gas spring characterized by;
the above mentioned piston (80″) depicts length adjustable gas spring that forms hole (86′) where the above mentioned pipe for gas transport (70*) or pipe for gas transport (70″) penetrates through; and groove (82′) that is formed in a way that the piston rod (90) is fixed based on the insertion of end part of the upper part (91) that is formed by riveting piston rod surface of upper part (92) of the small diameter of the piston rod (90) by being formed to approximately to 8/10 point of the piston's diameter from the side of the lower part.
groove (83″) inserted with O-ring (81″) that is comprised of elastic entity that tightens gas by being formed at the outer side of circumference of the upper part; hole (86″) where the above mentioned pipe for gas transport (70′) or pipe for gas transport (70″) penetrates through; groove (83′-1) that is inserted with the O-ring (84″) that is made of elastic entity at the inside of the hole (86″) for the sealing of gas between the above mentioned pipe for gas transport (70′) or pipe for gas transport (70″) and hole (86′); groove (85″) that is formed up to the 8/10 point of the piston's diameter from the side of the lower part and that is inserted and fixes the above mentioned piston rod (90′)'s radial type of end part of the upper part (91′); and the gas transport groove (87″) that is formed with gas transport groove (87″) that is formed at the center part of the upper part of the above mentioned groove (85″) to move between X chamber roor (X) and piston rod (90′).

13. When it relates to claim 1, length adjustable gas spring when it relates to the above mentioned piston rod (90′) is characterized by; surface of upper part (92) that is fixated into round shaped fixation board (91) by being input into the inner diameter part (82) of the above mentioned piston (80) by being formed at the upper part; surface of lower part (96) that is formed to enable the above mentioned retainer (150) and spindle support (130) to be inserted and that is formed at the lower part; surface of the middle part (95) that is input into the above mentioned rod guide (100), rod seal (110), cylinder (30)'s pass-through hole at the lower part (37) and vibration-proof rubber (170) and that is formed between the above mentioned surface of upper part (92) and surface of lower part (96); boundary side (93,94) in which the boundary part of the above mentioned upper, and surface of lower part (92,96) and surface of the middle part (95) are each comprised of rectangular gap; groove (97) that is formed so that the above mentioned clip (160) can be inserted and that is formed at the lower par of the above mentioned surface of lower part (96).

14. When it relates to claim 1, length adjustable gas spring when it relates to the above mentioned piston rod (90′) is characterized by; end part of the upper part (91′) that is projected in the form of radial that is inserted into the groove (85″) at the side of the piston (80″)'s lower part by being formed on the above mentioned piston rod (90′) is comprised of upper piston rod (90′) is comprised of upper part; part of lower side (94′) that is bent towards the inner side in the form of radial at the lower part; inner groove (92′) that is formed at the inside of the center and where gas sealing elastic entity (98′) and rod for lower side conjoining (93′) are inserted; and piston rod surface (95′) that assumes large diameter part that moves two-way by contacting with the inner side of circumference seal lip (114) of the rod seal (110) by being formed between the above mentioned end part of the upper part (91′) and part of lower side (94′).
Length Adjustable Gas Spring that forms conjoining projection (99′) for the prevention of separation by being fixated onto the above mentioned part of lower side (94′) when it comes to the upper part of rod for lower side conjoining (93′) that is inserted and conjoined with the above mentioned inner groove (92′); side of small diameter part (96′) that is inserted into vibration-proof rubber (170), retainer (150) and spindle support (130) by being formed at the lower part of the above mentioned conjoining projection; and groove (97′) where the clip (160) is inserted by being formed at the lower part of the above mentioned side of small diameter part (96′).

15. When it relates to claim 1, length adjustable gas spring characterized by; the above mentioned rod guide (100) is formed with inner side of circumference (101) of the cylinder shape that is formed inside the upper side; and center hole (105) that goes through the piston rod (90) that is formed at the center part.

16. When it relates to claim 1, length adjustable gas spring characterized by; the above mentioned rod seal (110) is comprised of; center hole (115) that is formed at the center; seal lip (113,114) that increases the ability to tighten gas by minimizing friction ability and that is configured into 3 to 5 layers at the outer side of circumference and inner side of circumference; groove (116) that is formed between the above mentioned seal lip (113,114); and metallic core material (111) that is composed in a way that the outer side of circumference (12) cannot move to the inner direction of the cylinder by the slightly projected upward projection boundary side (34) of the above mentioned cylinder (30) at the time of injecting high pressure gas by maintaining round shape under the high gas pressure by being included at the floor, making the outer diameter of the outer side of circumference (112) is made similar to the inner diameter of the inner side of the lower part's end part when it comes to the cylinder (30), and making it larger than the inner side of cylinder (35).

17. When it relates to claim 1, length adjustable gas spring characterized by; slide supplementary material (140) made of synthetic resin is injected in the upper part of the inner side when it comes to the outer drum (120). After its composition, at least one projection (121) is included at the inner side of the upper part to prevent separation. Moreover, at least two projections (123) was formed towards the inner direction at the tapered end part of the lower side part so that it will be symmetrical, both on the left and right side. At least two projections (122) are formed upward from the above mentioned projection (123). And spindle support (130) is placed and fixated between the above mentioned projections (122,123) without welding.

18. When it relates to claim 1, the above mentioned spindle support (130) as it relates to the length adjustable gas spring is characterized by; surface of the center part (134) of the rounded board; sloped part (131) that is formed to slope to specific angle towards the outer side of the above mentioned surface of the center part (134); and hole (132) where the lower part of the piston rod (90) that is at the center of the above mentioned surface of the center part (134) penetrates through to support weight of least 250 Kg.

19. When it relates to the operation method of the length adjustable gas spring, if and when the push bar (40) is pressed with force at a state when the gas is inside the cylinder (30) with fixed pressure, pipe for gas transport (70) moves towards the “A” direction. Gas transport hole (72′) that is at the upper side of the pipe for gas transport (70, 70′) moves to the Y chamber room (Y) from the center of the valve seal (60)'s inner side of circumference (62). Gas in the X chamber room (X) moves to the Y chamber room (Y) through passageway for gas transport (73, 73′) and gas transport hole (72, 72′). Accordingly, piston rod (90, 90″) moves to the “A” direction, and cylinder (30) increases towards the “B” direction due to opposing reaction since piston rod (90, 90″) is fixed onto the spindle support (130) that is inserted onto the outer drum (120) by the clip (160).
Moreover, if and when the external force that presses down on the push bar (40) is removed, pipe for gas transport (70, 70′) moves to the “B” direction by leveraging its own force due to the pressure of the gas of the X chamber room (X) at the inside of cylinder (30). Accordingly, gas transport hole (72, 72′) of pipe for gas transport (70, 70′) moves to the center hole (67) at the inside of the valve seal (60). Since the pass-through hole of the gas transport hole (72, 72′) is tightened, movement of gas between X chamber room (X) and Y chamber room (Y) stops, and the piston rod (90, 90″) stops to move. Accordingly, cylinder (30) stops to increase to the “B” direction.

20. When it relates to the operation method of the length adjustable gas spring, if and when the push pin (78″, 78*) is pressed with the force at a state when the gas is inside the cylinder (30) with fixed pressure, gas sealing hole (77″) at the lower part of the push pin (78″, 78*) moves towards the “A” direction, and is situated at the center part of the inside of swelled oval spherical surface (75″, 75*) of pipe for gas transport (70″, 70*) to penetrate through. Accordingly, gas of the X chamber room (X) moves from the X chamber room (X) to Y chamber room (Y) through passageway for gas transport (73″, 73*) and gas transport hole (72″, 72*). Piston rod (90, 90′) moves to the “A” direction, and cylinder (30) increases towards the “B” direction due to opposing reaction since piston rod (90, 90′) is fixed onto the spindle support (130) that is inserted onto the outer drum (120) by the clip (160).
Moreover, if and when the external force that presses the push pin (78″, 78*) is removed, gas sealing hole (77′, 77*) at the lower part of the push pin (78″, 78*) moves towards the “B” direction at the upper part of the swelled oval spherical surface (75*) due to the pressure of the gas of the X chamber room (X) that is at the inside of cylinder (30). As such, passing through of pipe for gas transport (70″, 70*)'s passageway for gas transport (73″, 73*) is blocked, which in turn stops the transportation of gas between X chamber room (X) and Y chamber room (Y). As a result, piston rod (90, 90′) stops to move and cylinder (30) stops increase into the “B” direction.
